(19) United States
(12) Patent Application Publication
(10) Pub. No.: US 2020/0000128 A1
(43) Pub. Date: Jan. 2, 2020

(54) MICROWAVE EGG PASTEURIZATION METHOD AND APPARATUS

(71) Applicant: CSIR, Pretoria (ZA)

(72) Inventors: Mathys Johannes Rossouw, Rayton (ZA); Pranitha Dawlal, Pretoria (ZA)

(73) Assignee: CSIR, Pretoria (ZA)

(21) Appl. No.: 16/488,091

(22) PCT Filed: Feb. 19, 2018
(86) PCT No.: PCT/IB2018/050995

§ 371 Date: Aug. 22, 2019

(30) Foreign Application Priority Data
Feb. 22, 2017 (ZA) 2017/01326

(51) Int. Cl. A23L 3/01; A23B 5/005; A23B 5/01; A23L 3/18; A23L 5/30; H05B 6/78

(52) U.S. Cl. CPC A23L 3/01; A23B 5/0052; A23B 5/01; H05B 2206/045; A23L 5/34; H05B 6/782; A23L 3/185

(57) ABSTRACT

An in-shell egg pasteurization process includes, in a temperature-raising stage (12), raising the temperature of yolk of a plurality of in-shell eggs (40), simultaneously and at least predominantly by means of microwave radiation, to a pasteurization temperature, the temperature-raising stage (12) including a plurality of elongate or longitudinally extending microwave cavities that are isolated from one another so that microwaves fed into an elongate or longitudinally extending microwave cavity do not leak into any other elongate or longitudinally extending microwave cavity. The in-shell eggs (40) are displaced along the lengths of the elongate or longitudinally extending microwave cavities whilst being irradiated with microwaves. In a pasteurization stage (14), the raised temperatures of the in-shell eggs (40) are maintained for a pasteurization time sufficient to pasteurize the in-shell eggs (40).

THIS INVENTION relates to the in-shell pasteurization of eggs. In particular, the invention relates to an in-shell egg pasteurization process and to an in-shell egg pasteurization machine or installation or apparatus.

U.S. Pat. No. 8,071,146 and U.S. Pat. No. 8,569,667, incorporated herein by reference, describe the problem of Salmonella enteritides infection of in-shell eggs, such as in-shell chicken eggs, and the difficulties experienced when attempting to pasteurize whole shell eggs when bearing in mind the required balance between reduction of target organisms and maintenance of albumen quality. Egg yolk proteins are generally more heat-stable than albumen proteins. However, as the target microorganisms are inside the egg yolk, yolk temperatures of in-shell eggs have to be raised high enough without damage to the albumen. U.S. Pat. No. 8,071,146 thus describes an in-shell egg pasteurization process which uses microwave radiation to raise the temperature of albumen of an in-shell egg to between 57° C. and 60° C., with the rate at which the albumen temperature is being raised reducing at least once over time. The external surfaces of the in-shell egg is also heated to a temperature of between 57° C. and 70° C., whereafter the albumen temperature and the shell temperature are maintained for a period of time sufficient to pasteurize the egg. During this process, the temperature of the yolk of the in-shell egg is raised, as a result of the microwave radiation, to a temperature higher than that of the albumen.

In order to develop a method and apparatus that can pasteurize in-shell eggs on a commercial scale using microwave irradiation, e.g. using the process of U.S. Pat. No. 8,071,146, and bearing in mind the substantial rate at which commercially available egg sorting and packaging machines can operate, the inventors have attempted, in secret, to use a conveyor with a plurality of in-shell eggs arranged in a two-dimensional matrix, e.g. in sixteen parallel columns of eggs (i.e. providing a plurality of rows each of sixteen eggs with the eggs being in a side-by-side relationship and with the eggs in a row being supported on one or more elongate egg supports), with the sixteen columns being passed together through a common microwave cavity wide enough to accommodate sixteen eggs side-by-side. This arrangement requires that the elongate egg supports, long enough to support sixteen eggs in side-by-side relationship and arranged transverse to a direction of travel of the eggs or conveyor through the microwave cavity, move through the common wide microwave cavity. This has however not worked in practice, as it turned out impossible to obtain a sufficiently homogenous temperature rise in the matrix of eggs passing through the microwave cavity, with some eggs becoming too hot and some eggs remaining too cold. Attempting to improve temperature homogeneity by having longitudinally extending divider walls depending from a roof of the microwave cavity, above the elongate egg supports, i.e. above the conveyor, also did not work. It was not possible to control the microwave heating in the various longitudinally extending, interconnected by the elongate egg supports of the conveyor, microwave sub-cavities formed between the longitudinally extending divider walls, sufficiently accurately to obtain sufficiently homogenous heating of the individual eggs in a transversely extending row of eggs for pasteurization purposes. As a result, some in-shell eggs in a transversely extending row of eggs would remain too cold, and some in-shell eggs in the same transversely extending row of eggs would become too hot.

A process and installation or apparatus or machine that can successfully pasteurize a plurality of in-shell eggs on a scale that is commercially attractive, using microwave irradiation, would be desirable.

According to one aspect of the invention, there is provided an in-shell egg pasteurization process which includes
in a temperature-raising stage, raising the temperature of yolk of a plurality of in-shell eggs, simultaneously and at least predominantly by means of microwave radiation, to a pasteurization temperature, the temperature-raising stage including a plurality of elongate or longitudinally extending microwave cavities that are isolated from one another so that microwaves fed into an elongate or longitudinally extending microwave cavity do not leak into any other elongate or longitudinally extending microwave cavity, with the in-shell eggs being displaced along the lengths of the elongate or longitudinally extending microwave cavities whilst being irradiated with microwaves; and
in a pasteurization stage, maintaining the raised temperatures of the in-shell eggs for a pasteurization time sufficient to pasteurize the in-shell eggs.

Typically, the in-shell eggs are thus not yet packaged, being in the form of individual, loose eggs that are displaced through the elongate or longitudinally extending microwave cavities to be heated at least predominantly by microwave radiation, without the need for a liquid heat transfer medium, such as hot water, to transfer heat to the in-shell eggs. The temperature-raising stage can thus be described as a dry temperature-raising stage.

In this specification, “predominantly” is to be interpreted to mean more than half. In other words, “raising the temperature of yolk of a plurality of in-shell eggs, simultaneously and at least predominantly by means of microwave radiation” means that more than half of the energy required to raise the temperature of the yolk of the eggs is provided by microwave radiation.

The pasteurization temperature of the yolk may be between 57° C. and 60° C., preferably between 58° C. and 60° C., more preferably between 59° C. and 60° C. As will be appreciated, as the yolk will become slightly hotter than the albumen during microwave irradiation, controlling or limiting the yolk temperature will also control or limit the albumen temperature, but to a slightly lower maximum temperature, ensuring that the more heat sensitive proteins of the albumen are not denatured to an unacceptable degree.

Preferably, the elongate or longitudinally extending microwave cavities are arranged side-by-side, with longitudinally extending axes of the elongate or longitudinally extending microwave cavities being parallel. The elongate or longitudinally extending microwave cavities may be in the form of rectangular or square tubes, with the in-shell eggs being displaced along the lengths of the tubes whilst being irradiated with microwaves. Openings of the tubes may be reduced in size to act as microwave chokes.

In one embodiment of the invention, the elongate or longitudinally extending microwave cavities are located in a common plane, preferably a common horizontal plane.

Displacing in-shell eggs along the length of an elongate or longitudinally extending microwave cavity preferably includes passing at least two, e.g. two, in-shell eggs in side-by-side relationship along the length of a longitudinally extending microwave cavity. In other words, the in-shell eggs may be arranged in at least two parallel columns, e.g. two parallel columns, with the in-shell eggs in adjacent columns being aligned in a direction transverse to the direction of travel of the in-shell eggs, and with the columns of in-shell eggs being displaced together, i.e. in lock-step fashion, through their longitudinally extending microwave cavity.

The inventors have found that having a single row of eggs moving through a correspondingly sized longitudinally extending microwave cavity (i.e. a microwave cavity or microwave tunnel that is just wide enough to accommodate one egg with some clearance from side walls to prevent arcing between the side walls and the egg) gives the smallest uncertainty in egg temperatures as the microwave field heating a particular egg is not affected by the presence of an adjacent egg (adjacent in a direction transverse to the direction of travel). A process employing a machine or installation employing multiple narrow microwave cavities or tunnels each with a single row of eggs will however be expensive from a capital expenditure perspective, even though it provides more flexibility as the eggs can be graded into fine weight bands and heated to the tightest temperature range.

A process employing a machine or installation employing multiple microwave cavities or tunnels with two or more columns of eggs passing longitudinally through each microwave cavity or tunnel would be less expensive from a capital expenditure perspective, as it would have a smaller component count. Temperature regulation of eggs in such microwave cavities must however not be affected to an unacceptable degree as a result of neighbouring eggs perturbing the microwave field distribution across the width of the microwave cavity. Naturally, a two-egg microwave cavity or tunnel should be just wide enough to accommodate two eggs in side by side arrangement with some clearance from side walls to prevent arcing between the side walls and the eggs.

The inventors have found that there is a limit to the width of, and hence to the number of columns of in-shell eggs that can be accommodated by, an elongate or longitudinally extending microwave cavity that still guarantees an acceptably constant or uniform microwave field extending between opposed side walls of the elongate or longitudinally extending microwave cavity. This limit is dependent on the frequency (or wavelength) of the microwaves fed into an elongate or longitudinally extending microwave cavity.

In one embodiment of the invention, at least two of the number of columns of in-shell eggs in an elongate or longitudinally extending microwave cavity, the microwave frequency and the microwave wavelength are selected from Table 1 below. Also the width of each longitudinally extending microwave cavity may be selected from Table 1, depending on the number of columns of in-shell eggs in a longitudinally extending microwave cavity.

TABLE 1

| | | | Elongate or |
|---|---|---|---|
| Columns of in-shell | | | longitudinally |
| eggs in an elongate or | | | extending |
| longitudinally | Microwave | Microwave | microwave |
| extending microwave | frequency | wavelength | cavity width |
| cavity | range (GHz) | range (cm) | range (cm) |
| 1 | 0.3-10 | 3-100 | 7-15 |
| 2 | 0.3-2.5 | 12-100 | 14-25 |
| 3 | 0.3-1.5 | 20-100 | 21-30 |
| 4 | 0.3-1 | 30-100 | 28-40 |

The in-shell eggs being displaced along the length of an elongate or longitudinally extending microwave cavity may be arranged with a longitudinal axis of each in-shell egg being transverse to the direction of travel of the in-shell egg.

Preferably, adjacent in-shell eggs in a longitudinally extending column of in-shell eggs are spaced at least about 5 mm, more preferably at least about 8 mm, most preferably at least about 10 mm apart.

Preferably, adjacent in-shell eggs in a longitudinally extending column of in-shell eggs are spaced no more than about 50 mm, more preferably no more than about 25 mm, most preferably no more than about 10 mm apart.

Preferably, when at least two adjacent longitudinally extending columns of in-shell eggs are displaced through a longitudinally extending microwave cavity, transversely spaced, transversely aligned in-shell eggs are spaced at least about 3 mm, more preferably at least about 5 mm, most preferably at least about 10 mm apart.

Preferably, when at least two adjacent longitudinally extending columns of in-shell eggs pass through a longitudinally extending microwave cavity, transversely spaced, transversely aligned in-shell eggs are spaced no more than about 50 mm, more preferably no more than about 25 mm, most preferably no more than about 10 mm apart.

Preferably, when two adjacent longitudinally extending columns of in-shell eggs pass through a longitudinally extending microwave cavity, adjacent in-shell eggs in a direction transverse to the direction of travel of the columns of eggs have their more rounded or less tapered or blunter ends facing each other. These are the ends containing the air sacks of the in-shell eggs. Thus, when two adjacent longitudinally extending columns of eggs pass through a longitudinally extending microwave cavity, the less rounded or more tapered or more pointed ends of in-shell eggs in a longitudinally extending column of eggs preferably face towards a side wall of the longitudinally extending microwave cavity.

The process may include generating microwaves for the elongate or longitudinally extending microwave cavities using a single or common microwave generator, e.g. a magnetron, and feeding microwaves generated by the single or common microwave generator into each elongate or longitudinally extending microwave cavity that has eggs passing through the elongate or longitudinally extending microwave cavity.

The process may include employing one or more, e.g. two, four or eight microwave splitters, to split total microwave power generated by the microwave generator into microwave power portions, and feeding portions of microwave power so obtained to each elongate or longitudinally extending microwave cavity that has eggs passing through the elongate or longitudinally extending microwave cavity. The splitters may be adjustable or controllable, and may form part of a closed control loop.

As will be appreciated, the microwave power required to heat in-shell eggs to the pasteurization temperature is proportional to the mass of in-shell eggs passing through an elongate or longitudinally extending microwave cavity. Hence, the process may include adjusting the amount of microwave power to each elongate or longitudinally extending microwave cavity in order to control the temperature of the eggs. For example, the process may include electrically adjusting the microwave splitters to control the amount of microwave power being fed to individual elongate or longitudinally extending microwave cavities. Once a steady state of operation has been reached, it is expected that little adjustment (say less than 10% more or less than an average feed microwave power to an elongate or longitudinally extending microwave cavity) of microwave power being fed into an elongate or longitudinally extending microwave cavity will be required (assuming a constant feed of eggs graded to fall within an appropriate weight band).

The process may include heating a floor and/or side walls of the longitudinally extending microwave cavities, thereby to also heat at least the external or shell surfaces of the in-shell eggs by means of heat radiation or thermal radiation. This heating may be electrically, e.g. by ohmic or resistance heating, and assists in reducing heat loss from the in-shell eggs being irradiated with microwaves, and hence allows the egg shell temperatures to become hot enough for pasteurization purposes.

The floor and/or the side walls of the longitudinally extending microwave cavities may be heated to a temperature within a range of about 55° C. to about 65° C., e.g. about 60° C.

The process may include moving hot air through the temperature-raising stage whilst the temperature of yolk of a plurality of in-shell eggs are being raised simultaneously and at least predominantly by means of microwave radiation to a pasteurization temperature. The hot air may be at a temperature of between about 40° C. and about 70° C., preferably between about 50° C. and about 65° C., more preferably between about 55° C. and about 60° C., e.g. about 58° C. The hot air may be supplied from the pasteurization stage and may flow in an upstream direction along each of the elongate or longitudinally extending microwave cavities, i.e. against the direction of travel of the in-shell eggs.

The external surfaces of the in-shell eggs may be heated to a temperature of between 57° C. and 70° C. in the temperature-raising stage, preferably to a temperature of between 57° C. and 60° C., more preferably to a temperature of between 58° C. and 60° C. This temperature rise is typically as a result of microwave irradiation (which provides more than half of the input energy required) and convection heating, or as a result of microwave irradiation and heat or thermal radiation, or as a result of microwave irradiation and convection heating and heat or thermal radiation.

The process may include turning eggs passing through an elongate or longitudinally extending microwave cavity about their longitudinal axes at least while they are within the elongate or longitudinally extending microwave cavity. Preferably, the eggs are also turned about their longitudinal axes when they are within the pasteurization stage.

The eggs may be turned at a rate of one revolution per 0.05 m to about 1 m, preferably at a rate of 1 revolution per about 0.05 m to about 0.5 m, most preferably at a rate of 1 revolution per about 0.2 m to about 0.3 m, e.g. about 1 revolution per about 0.25 m.

The microwaves may be fed from above into the elongate or longitudinally extending microwave cavities, e.g. through a roof of each elongate or longitudinally extending microwave cavity.

In one embodiment of the invention, microwaves are fed from a feed waveguide located above and associated with an elongate or longitudinally extending microwave cavity, into said elongate or longitudinally extending microwave cavity. The feed waveguide may be parallel with and directly above its associated elongate or longitudinally extending microwave cavity. A roof of the elongate or longitudinally extending microwave cavity may define a floor of its associated feed waveguide. Microwave coupling between the feed waveguide and its associated elongate or longitudinally extending microwave cavity may be by means of one or more openings in the roof of the elongate or longitudinally extending microwave cavity. The openings may be located centrally, i.e. midway, between sides of an elongate or longitudinally extending microwave cavity.

The temperature of the yolk of said plurality of eggs in the temperature-raising stage may be raised at a rate which reduces at least once along the length of an elongate or longitudinally extending microwave cavity, whilst the eggs pass through the elongate or longitudinally extending microwave cavity. In other words, an upstream portion of an elongate or longitudinally extending microwave cavity may receive more microwave power than a downstream portion of the same elongate or longitudinally extending microwave cavity. Microwave power density in an elongate or longitudinally extending microwave cavity may thus be profiled to reduce at least once, preferably more than once, so that the microwave power density is profiled to progressively reduce the heating rate of in-shell eggs passing through the elongate or longitudinally extending microwave cavity.

In one embodiment of the invention, the openings in the roof of each elongate or longitudinally extending microwave cavity are in the form of spaced slots, with the slots reducing in dimensions in a direction of egg travel, and with the spacing between slots determined by the wavelength of the microwave field. Typically, the slots have longitudinal axes parallel to the longitudinal axes of the elongate or longitudinally extending microwave cavities. This arrangement preferably results in the heating rate of eggs passing through the elongate or longitudinally extending microwave cavity reducing along an approximate inverse logarithmic curve as a function of position inside the elongate or longitudinally extending microwave cavity.

The process may include elevating the in-shell eggs in an elongate or longitudinally extending microwave cavity above a floor of the elongate or longitudinally extending microwave cavity.

Preferably, the eggs are elevated between about 5 mm and about 50 mm, more preferably between about 10 mm and about 30 mm, most preferably between about 15 mm and about 20 mm, above the floor of an elongate longitudinally extending microwave cavity.

The process may includes measuring a surface temperature of in-shell eggs inside an elongate or longitudinally extending microwave cavity, and correlating the yolk temperature of the eggs based on the surface temperature. Such a correlation may be a linear correlation, with the in-shell egg surface temperature being slightly lower (e.g. about 1° C. to about 3° C. lower) than the egg yolk temperature. The process may thus include controlling the surface temperature of the in-shell eggs at a selected or predetermined location within each of the longitudinally extending microwave cavities, e.g. at the outlet of each longitudinally extending microwave cavity, thereby indirectly controlling the yolk temperature of the in-shell eggs (to a temperature slightly higher than that of the shell surface). Preferably, the surface temperature of the in-shell eggs is controlled within a narrow range of no more than about 1.5° C. below or above a desired or reference surface temperature.

The surface temperature of the in-shell eggs may be measured by means of infrared sensors, in particular passive infrared sensors. The infrared sensors may be located above the in-shell eggs, where the eggs exit an elongate or longitudinally extending microwave cavity.

The process may include displacing in-shell eggs along the lengths of the elongate or longitudinally extending microwave cavities on dedicated conveying means associated with each elongate or longitudinally extending microwave cavity.

The conveying means of an elongate or longitudinally extending microwave cavity may include an endless egg support fed lengthwise through the elongate or longitudinally extending microwave cavity and configured to be displaced in a longitudinal direction of the elongate or longitudinally extending microwave cavity. The endless egg support may enter the elongate or longitudinally extending microwave cavity through an inlet at one end of the elongate or longitudinally extending microwave cavity and may leave the elongate or longitudinally extending microwave cavity through an outlet at an opposed, i.e. downstream, end of the elongate or longitudinally extending microwave cavity. Typically, when inside the elongate or longitudinally extending microwave cavity, the endless egg support is supported on the floor of the elongate or longitudinally extending microwave cavity, and is located between the side walls of the elongate or longitudinally extending microwave cavity, with no portion of the endless egg support extending transversely beyond the side walls, e.g. into an adjacent elongate or longitudinally extending microwave cavity. As will be appreciated, this allows adjacent elongate or longitudinally extending microwave cavities to be isolated from each other, with microwave impenetrable side walls, thereby to ensure the microwaves fed into an elongate or longitudinally extending microwave cavity do not leak from said elongate or longitudinally extending microwave cavity into an adjacent elongate or longitudinally extending microwave cavity.

The endless egg supports of the plurality of elongate longitudinally extending microwave cavities may be driven by a common drive, so that the endless egg supports are all displaced at a common speed through their associated elongate or longitudinally extending microwave cavities.

In one embodiment of the invention, the endless egg supports are driven by geared drive wheels located on a common drive shaft, with the endless egg supports being in the form of chains comprising plates with rotatable egg supporting formations extending between the plates to support two or more columns of spaced in-shell eggs.

The endless egg supports may be configured and dimensioned to space, orientate and/or elevate in-shell eggs as hereinbefore described.

The process may include, in the pasteurization stage, maintaining raised in-shell egg temperatures by means of convection heating, e.g. by means of hot air. The hot air may be slightly warmer than the temperature at which it is desired that the egg shells be kept, e.g. about 2° C. to about 5° C. warmer. The purpose of the hot air is predominantly to inhibit heat loss from the in-shell eggs inside the pasteurization stage. The heat loss may at least partially be as a result of moisture loss from the in-shell eggs. In one embodiment of the invention, no heating of the in-shell eggs by means of microwave radiation takes place inside the pasteurization stage. The pasteurization stage may thus be free of a microwave cavity.

Each in-shell egg may have a residence time in the temperature-raising stage of at least about 3 minutes, preferably at least about 5 minutes, more preferably at least about 10 minutes, e.g. about 12 minutes.

Each in-shell egg may have a residence time in the temperature-raising stage of at most about 45 minutes, preferably at most about 30 minutes, more preferably at most about 17 minutes.

Each in-shell egg may have a residence time in the pasteurization stage of at least about 7 minutes, preferably at least about 20 minutes, more preferably at least about 35 minutes, e.g. about 40 minutes.

Each in-shell egg may have a residence time in the pasteurization stage of at most about 90 minutes, preferably at most about 60 minutes, more preferably at most about 45 minutes.

The process may include transferring in-shell eggs exiting the temperature-raising stage immediately into the pasteurization stage. In other words, the temperature-raising stage and the pasteurization stage may be immediately adjacent each other, with the conveying means being arranged to displace eggs through both the temperature-raising stage and the pasteurization stage. In one embodiment of the invention, the endless egg supports are thus fed lengthwise through both the temperature-raising stage and the pasteurization stage.

According to another aspect of the invention, there is provided an in-shell egg pasteurization machine or installation which includes
a temperature raising stage to raise the temperatures of in-shell eggs by means of microwave radiation, the temperature raising stage including a plurality of elongate or longitudinally extending microwave cavities that are isolated from one another so that microwaves fed into one elongate or longitudinally extending microwave cavity do not leak into any other elongate or longitudinally extending microwave cavity; and
a pasteurization stage configured to maintain raised temperatures of in-shell eggs received from the temperature raising stage for a pasteurization time sufficient to pasteurize the in-shell eggs.

Typically, the machine or installation includes conveying means passing longitudinally through each elongate or longitudinally extending microwave cavity to displace in-shell eggs along the lengths of the elongate or longitudinally extending microwave cavities. Preferably, the conveying means also passes through the pasteurization stage to displace in-shell eggs received from the temperature raising stage through the pasteurization stage.

The temperature raising stage may be as hereinbefore described.

The pasteurization stage may be as hereinbefore described.

The elongate or longitudinally extending microwave cavities may be as hereinbefore described.

The elongate or longitudinally extending microwave cavities may have a width selected from Table 1 hereinbefore, to accommodate a selected number of columns of in-shell eggs.

Instead, the elongate or longitudinally extending microwave cavities may have a width between about 6 cm and about 15 cm, preferably between about 6 cm and about 12 cm, more preferably between about 7 cm and about 10 cm, thereby to accommodate a single column of in-shell eggs.

Alternatively, the elongate or longitudinally extending microwave cavities may have a width of between about 14 cm and about 25 cm, preferably between about 14 cm and about 20 cm, more preferably between about 16 cm and about 18 cm, thereby to accommodate two parallel columns on in-shell eggs in side-by-side relationship.

Instead, the elongate or longitudinally extending microwave cavities may have a width of between about 21 cm and about 40 cm preferably between about 21 cm and about 30 cm, more preferably between about 22 cm and about 25 cm, thereby to accommodate three parallel columns of in-shell eggs in side-by-side relationship.

The conveying means may be as hereinbefore described.

Preferably, the conveying means is configured to support in-shell eggs in an elongate or longitudinally extending microwave cavity with a longitudinal axis of each in-shell egg arranged transverse to a longitudinal direction of the elongate or longitudinally extending microwave cavity.

The conveying means may be configured to space and/or elevate in-shell eggs as hereinbefore described, and/or to support in-shell eggs with an orientation as hereinbefore described, and/or to turn in-shell eggs as hereinbefore described.

The machine or installation may include one or more microwave generators. The microwave generator may be connected to each elongate or longitudinally extending microwave cavity by means of one or more microwave waveguides to feed microwaves into each elongate or longitudinally extending microwave cavity. The microwave generator may be configured to generate microwaves within a frequency range and/or wavelength range selected from Table 1 hereinbefore.

The machine or installation may include microwave splitters as hereinbefore described. Typically, the machine or installation includes a controller, preferably a programmable controller, to control by means of the microwave splitters the amount of microwave power fed into each longitudinally extending microwave cavity.

The machine or installation may include heated floor and/or side walls defining the elongate or longitudinally extending microwave cavities. In other words, the machine or installation may include heating means to heat the floor and/or side walls of the elongate longitudinally extending microwave cavities. The heating means may be ohmic or resistance heating means.

The machine or installation may include a hot air generator to generate or produce hot air for the pasteurization stage. The hot air generator may also be configured to displace hot air through each of the elongate or longitudinally extending microwave cavities.

The controller may be configured to control microwave power to each longitudinally extending microwave cavity such that the yolks of the eggs in the temperature raising stage are raised to a pasteurization temperature. The pasteurization temperature may be as hereinbefore described.

The controller may be configured to receive as set points or references the surface temperature of in-shell eggs at a selected or predetermined location within each of the longitudinally extending microwave cavities. Preferably, the controller is configured to control the surface temperature of in-shell eggs at a selected or predetermined location within each of the longitudinally extending microwave cavities within a narrow range of no more than about 1.5° C. above or below the set point or reference surface temperature for that longitudinally extending microwave cavity.

The machine or installation may include temperature sensors to measure the surface temperature of in-shell eggs. The temperature sensors may be infrared sensors as hereinbefore described. The temperature sensors may provide in-shell egg surface temperature inputs to the controller, allowing the controller to function with a closed feedback control loop.

In one embodiment of the invention, the machine or installation includes microwave splitters to split total microwave power generated by a microwave generator into microwave power portions, and to feed portions of microwave power so obtained to each elongate or longitudinally extending microwave cavity configured for eggs to pass through the elongate or longitudinally extending microwave cavity, and a controller configured to control microwave power to each elongate or longitudinally extending microwave cavity such that the yolks of the eggs in the temperature raising stage are raised to a pasteurization temperature, the controller being configured to receive as set points or references the surface temperature of in-shell eggs at a selected or predetermined location within each of the elongate or longitudinally extending microwave cavities.

Each elongate or longitudinally extending microwave cavity may be configured to receive microwaves from above, e.g. through a roof of an elongate or longitudinally extending microwave cavity. Each elongate or longitudinally extending microwave cavity may be associated with a feed waveguide as hereinbefore described.

The temperature raising stage may be configured in use to raise the temperature of yolk of said plurality of eggs at a rate which reduces at least once along the length of an elongate or longitudinally extending microwave cavity. In other words, in use, an upstream portion of an elongate or longitudinally extending microwave cavity may receive more microwave power than a downstream portion of the same elongate or longitudinally extending microwave cavity. Microwave power density in an elongate or longitudinally extending microwave cavity may thus be as hereinbefore described. Each elongate or longitudinally extending microwave cavity may thus have a roof with openings as hereinbefore described.

The invention will now be described, by way of example, with reference to the accompanying diagrammatic drawings, in which

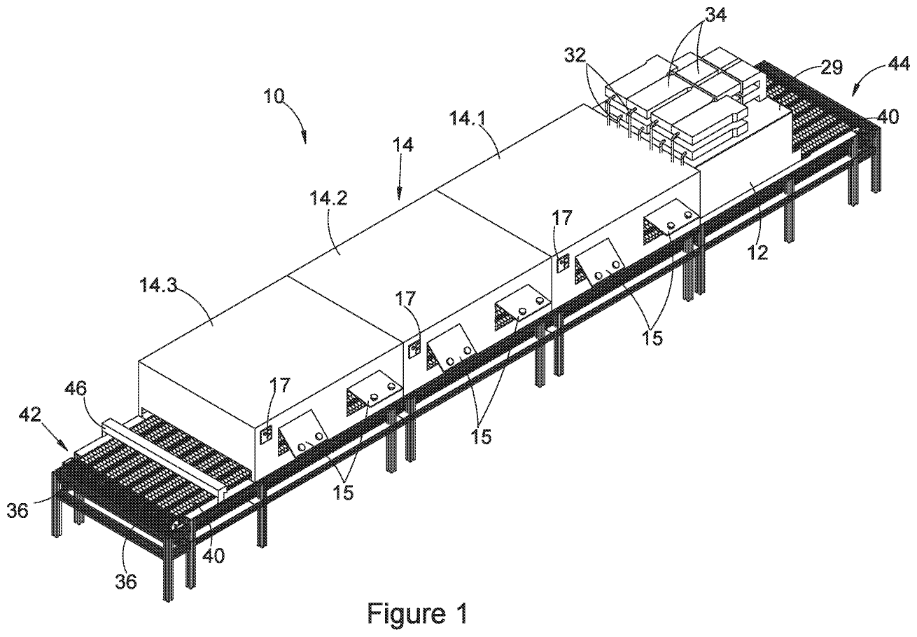

FIG. 1 shows a three-dimensional view of one embodiment of an in-shell egg pasteurization machine in accordance with the invention;

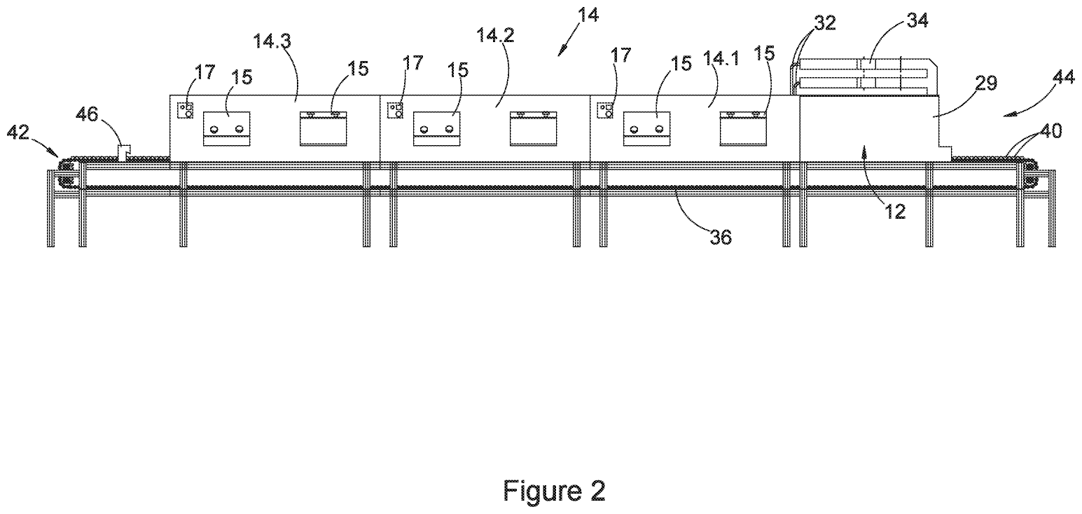

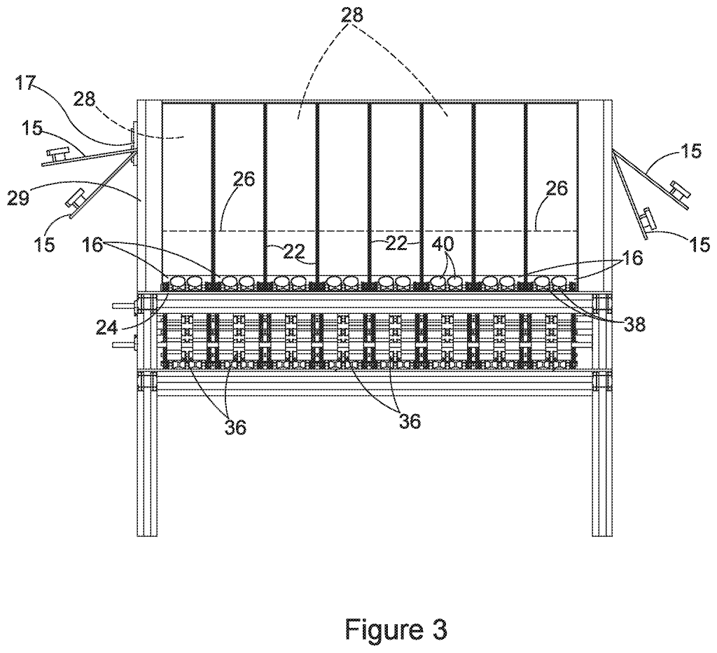

FIG. 2 shows a side view of the in-shell egg pasteurization machine of FIG. 1; FIG. 3 shows a feed end view of the in-shell egg pasteurization machine of FIG. 1, but omitting certain features such as microwave splitters;

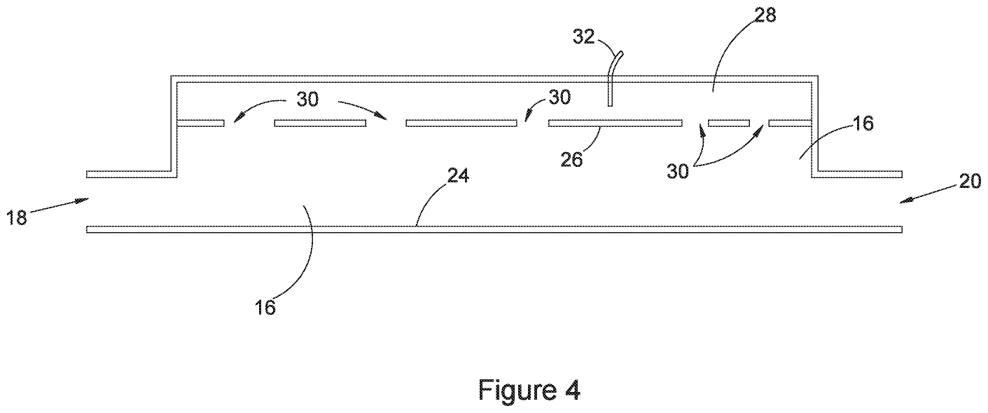

FIG. 4 shows a vertical longitudinal section through a feed waveguide and a longitudinally extending microwave cavity of the in-shell egg pasteurization machine of FIG. 1.

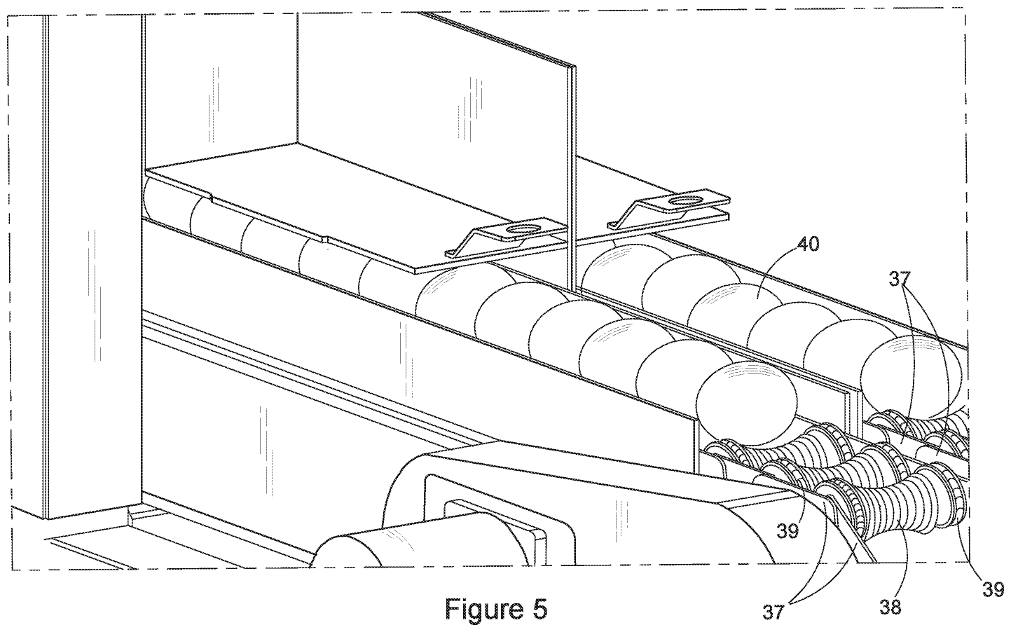

FIG. 5 shows a three-dimensional view of a portion of an in-shell egg pasteurization machine in accordance with the invention with a pair of microwave cavities each configured to accommodate a single column of eggs;

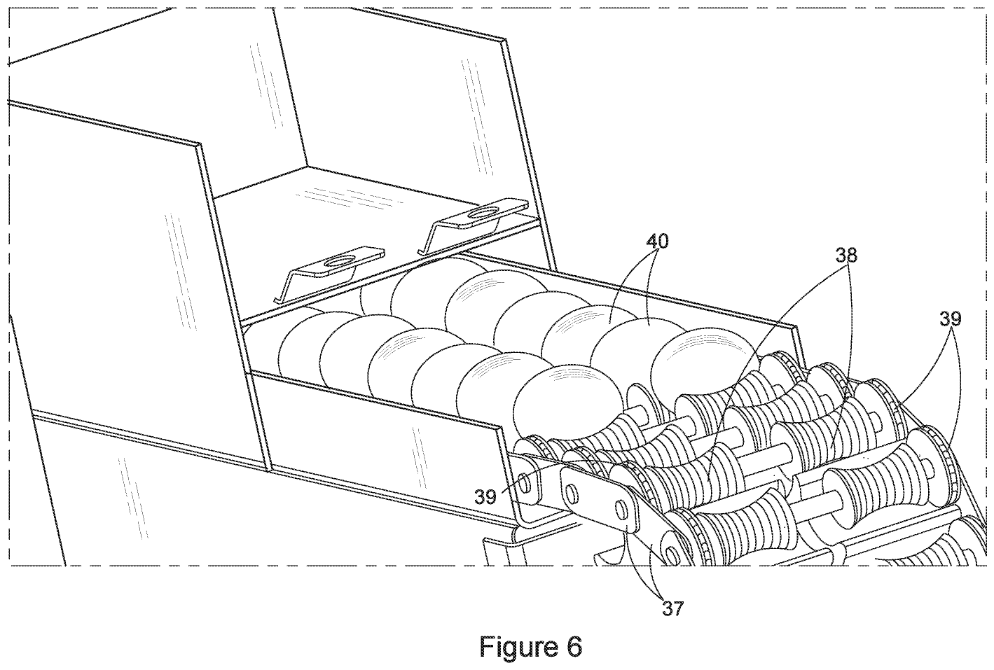

FIG. 6 shows a three-dimensional view of a portion of a single longitudinally extending microwave cavity configured to accommodate two columns of eggs, used to investigate microwave field distribution and in-shell egg heating rates in such a microwave cavity;

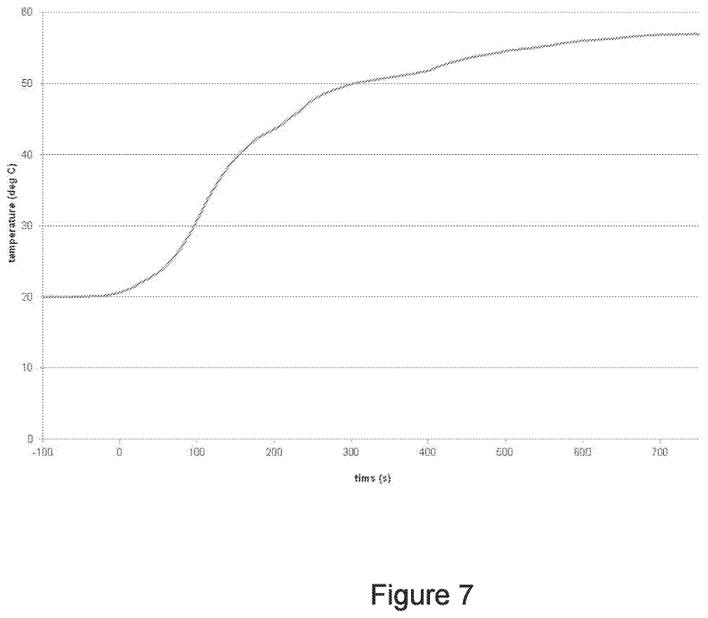

FIG. 7 shows a graph of the temperature of the yolk of an in-shell egg as a function of time, where the egg is pasteurized using the machine of FIG. 1;

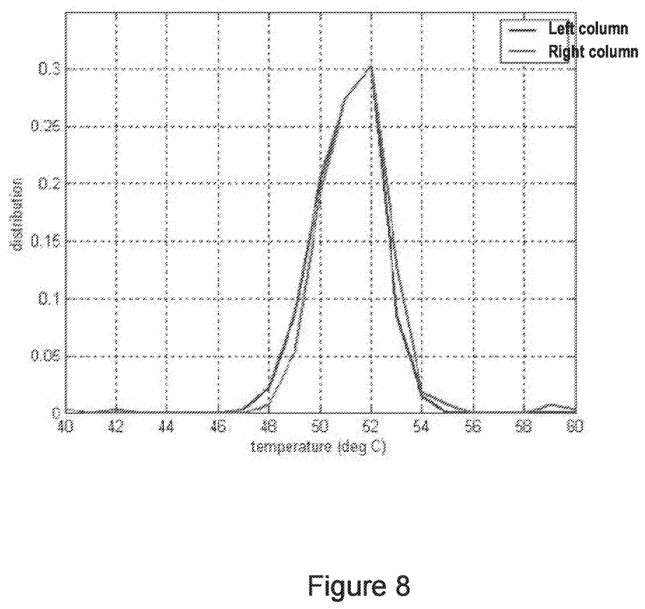

FIG. 8 shows a graph of the distribution of external egg shell temperatures of two columns of in-shell eggs, i.e. a left column and a right column, heated in the experimental longitudinally extending microwave cavity of FIG. 6;

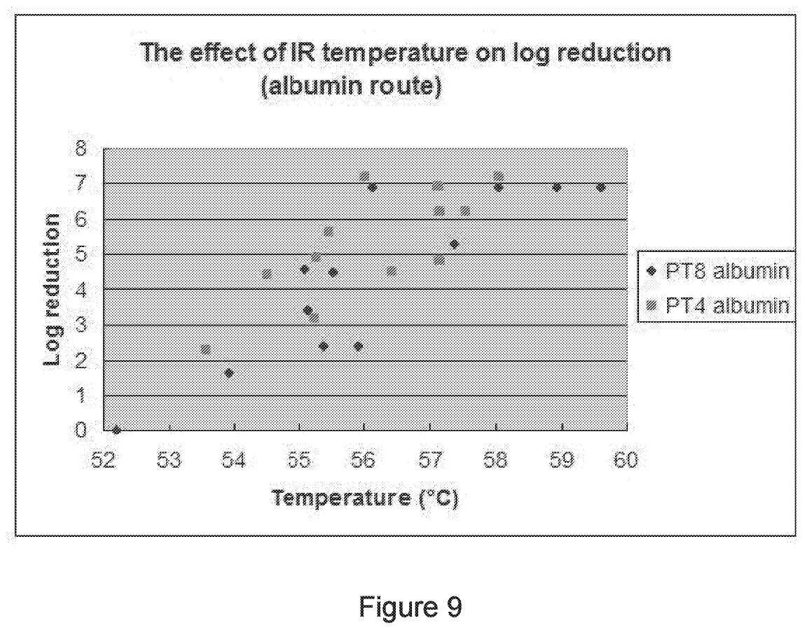

FIG. 9 shows the log reduction in salmonella enteritidis phage types, in two batches of eggs indicated as PT8 and PT4, as a function of egg shell temperature as measured by infrared temperature sensors, when pasteurized using the machine of FIG. 1;

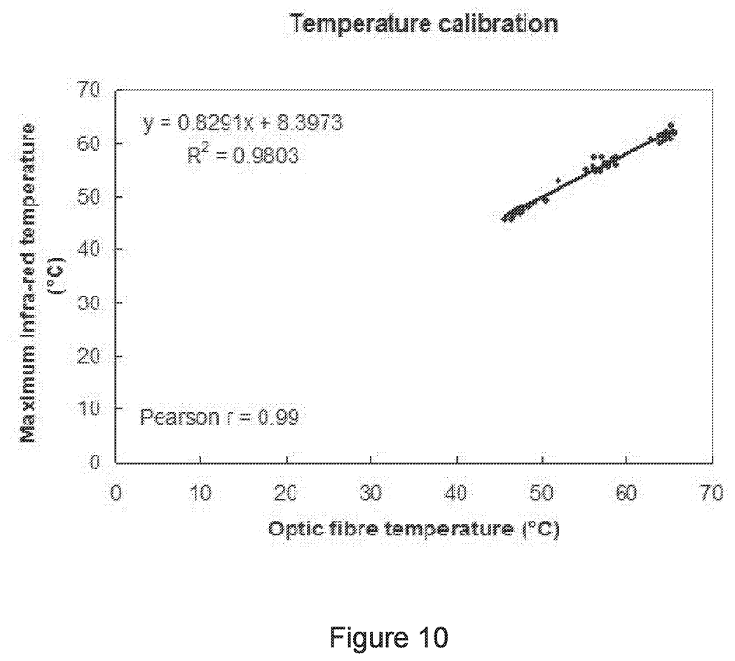

FIG. 10 shows a graph of the linear relationship between the external egg shell temperature measured by infrared temperature sensor and the temperature of the yolk of the egg measured by means of an optic fibre inserted into the egg;

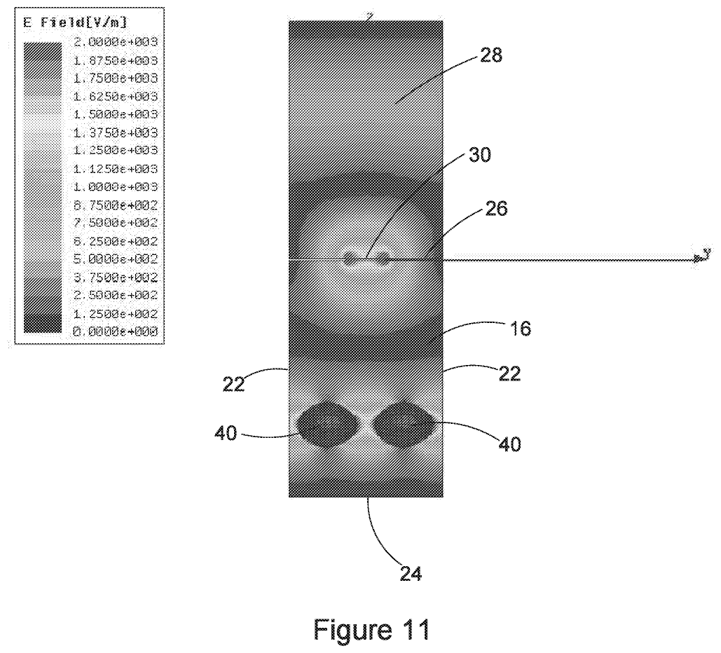

FIG. 11 shows the microwave electric field distribution in the experimental longitudinally extending microwave cavity of FIG. 6, with two eggs positioned side-by-side inside the microwave cavity and with the microwaves being fed from a feed waveguide positioned above the longitudinally extending microwave cavity; and

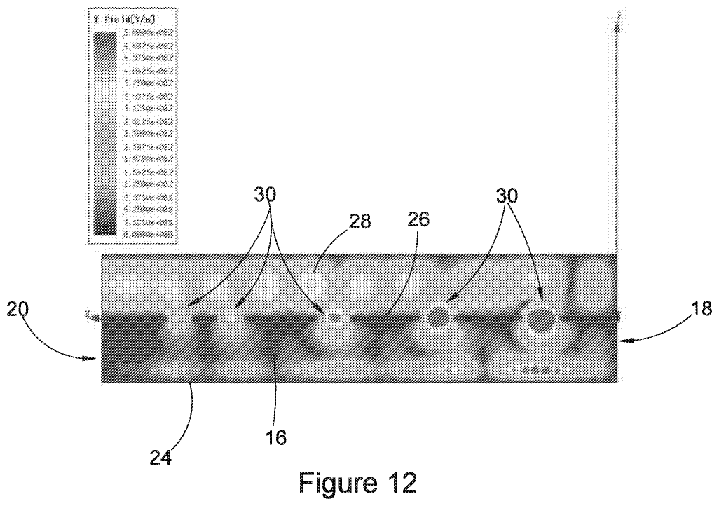

FIG. 12 shows the microwave electric field distribution along the length of the experimental longitudinally extending microwave cavity of FIG. 6, with the microwaves being fed from a feed waveguide positioned above the longitudinally extending microwave cavity.

Referring to FIG. 1 of the drawings, reference numeral 10 generally indicates an in-shell egg pasteurization machine in accordance with the invention. The machine 10 generally includes a temperature raising stage 12 and a pasteurization stage 14 immediately adjacent the temperature raising stage 12. The machine 10 as illustrated is modular, with the temperature raising stage 12 comprising one module and the pasteurization stage 14 comprising three modules 14.1, 14.2 and 14.3 fitted together to form the pasteurization stage 14.

The temperature raising stage 12 includes eight elongate or longitudinally extending microwave cavities 16 (see FIG. 3) that are isolated from one another so that microwaves fed into one longitudinally extending microwave cavity 16 do not leak into any other longitudinally extending microwave cavity 16. Each longitudinally extending microwave cavity 16 is thus in the form of a rectangular tube of stainless steel, with a vertical longitudinal section as shown in FIG. 4. As will be noticed from FIG. 4, an inlet 18 and an outlet 20 of the longitudinally extending microwave cavity 16 have a reduced height compared to the rest of the longitudinally extending microwave cavity 16, with the reductions acting as microwave chokes in use to inhibit escape of microwaves from the longitudinally extending microwave cavity 16.

Each longitudinally extending microwave cavity 16 thus has side walls 22, a floor 24 and a roof 26 formed from stainless steel sheeting with a thickness of about 2 mm. The side walls 22 between adjacent longitudinally extending microwave cavities 16 are not shared, i.e.

each longitudinally extending microwave cavity 16 is defined between its own side walls 22, floor 24 and roof 26, with the side walls 22, floor 24 and roof 26 defining a rectangular, elongate tube.

The longitudinally extending microwave cavities 16 are arranged side-by-side, with longitudinally extending axes of the longitudinally extending microwave cavities 16 being parallel and being in a common horizontal plane. Each longitudinally extending microwave cavity 16 has an internal width of about 170 mm and a length of about 2.4 m, allowing the longitudinally extending microwave cavities 16 each to accommodate two columns of in-shell eggs in a side-by-side arrangement for example as shown in FIG. 3 of the drawings.

The floor 24 and side walls 22 of each longitudinally extending microwave cavity 16 are electrically heated by means of resistance heating, with the heating being controlled.

Each longitudinally extending microwave cavity 16 is associated with a longitudinally extending microwave feed waveguide 28 (see FIGS. 3 and 4) extending between the inlet 18 and the outlet 20 of its associated longitudinally extending microwave cavity 16. The feed waveguides 28 are also formed from stainless steel sheeting. The side walls 22 of the longitudinally extending microwave cavity 16 are extended upwardly to define side walls of its associated feed wave guide 28 and the roof 26 of a longitudinally extending microwave cavity 16 defines a floor of its associated feed wave guide 28. Each longitudinally extending microwave cavity 16 and its associated feed waveguide 28 thus together form a modular unit separate from other identical modular units.

The modular units each comprising a longitudinally extending microwave cavity 16 and its associated feed waveguide 28 are positioned side by side inside a housing 29, with heat insulating material (not shown) sandwiched between the housing 29 and the modular units.

Microwave coupling openings 30 are provided in the roof 26 of a longitudinally extending microwave cavity 16. The openings 30 are in the form of spaced longitudinally extending slots reducing in length along the length of the longitudinally extending microwave cavity 16. The openings 30 are located centrally between the side walls 22 of the longitudinally extending microwave cavity 16. In use, microwaves are thus fed from above into each longitudinally extending microwave cavity 16 through the longitudinally spaced microwave coupling openings 30 in the roof 26 of the longitudinally extending microwave cavity 16. The microwaves are generated by or in a common microwave generator, such as a magnetron (not shown) and fed by means of microwave splitters 34 and antennas 32 (see FIG. 1) to the feed waveguides 28. The amount of microwave power radiated by means of an antenna 32 into each feed waveguide 28 is controlled by means of the microwave splitters 34, with the microwave splitters 34 in turn being controlled by means of a programmable controller (not shown). Generating, splitting and controlling microwave power are activities well-known to a person skilled in the art and not the focus of the invention and a further description thereof is thus not provided herein.

The pasteurization stage 14 includes said three modules 14.1, 14.2 and 14.3 pushed together to define a longitudinally extending heating cavity within which the temperature of in-shell eggs, raised by means of microwave radiation in the temperature raising stage 12, can be maintained for a pasteurization time sufficient to pasteurize the in-shell eggs. Each module 14.1, 14.2 and 14.3 of the pasteurization stage 14 includes a plurality of electrical heating rods (not shown), arranged to extend lengthwise underneath a roof of the module. These heating rods form part of a hot air generator which also includes a fan or blower (not shown) to agitate the hot air and to displace the hot air slowly through the pasteurization stage 14 and also through the longitudinally extending microwave cavities 16 from their outlets 20 to their inlets 18. Each module 14.1, 14.2, 14.3 of the pasteurization stage 14 also includes a pair of thermocouples (not shown) suspended more or less centrally from the roof of the module 14.1, 14.2, 14.3 to measure the air temperature inside the module 14.1, 14.2, 14.3. Two normally closed inspection doors 15 are provided on both sides of each module 14.1, 14.2, 14.3 of the pasteurization stage 14, and each module 14.1, 14.2, 14.3 of the pasteurization stage 14 also has its own PID temperature controller 17 for controlling the air temperature inside the module by means of the electrical heating rods. No microwaves are in use fed into the pasteurization stage 14 from the microwave generator.

Each longitudinally extending microwave cavity 16 is provided with conveying means to displace individual, loose, unpackaged in-shell eggs longitudinally through the longitudinally extending microwave cavity 16. The conveying means comprises an endless egg support 36 fed lengthwise through its associated longitudinally extending microwave cavity 16. The endless egg supports 36 of all of the longitudinally extending microwave cavities 16 resemble a chain and are each driven by means of a pair of geared drive wheels at a feed end 44 of the pasteurization machine 10, with the pairs of geared drive wheels at the feed end 44 all being located on a common drive shaft driven at a fixed rate by means of an electric motor. The endless egg supports 36 of the various longitudinally extending microwave cavities 16 thus all move at the same speed. Idler geared wheels, also arranged in pairs on a common shaft, are located at a lower elevation than the geared drive wheels, at the feed end 44. If desired however, the lower geared wheels may also be driven so that they do not merely idle.

Each endless egg support 36 is in the form of a chain formed by plates or links 37 (see FIGS. 5 and 6), but instead of having conventional link pins and rollers or bushes, the link pins and rollers of the chain are in the form of rotatable egg supporting formations 38. In other words, instead of having a link pin and a roller extending between the plates or links 37 of the chain, the endless egg support 36 has rotatable egg supporting formations 38 for supporting eggs. The plates or links 37 and egg supporting formations 38 are of a synthetic plastics or polymeric material suitable for use in a microwave cavity. Each rotatable egg supporting formation 38 has a pair of solid silicone tyres 39 on which they run, e.g. when inside a longitudinally extending microwave cavity 16.

The rotatable egg supporting formations 38 are configured to support a pair of in-shell eggs 40 in side-by-side relationship between four of the egg supporting formations 38, in the arrangement shown in FIG. 6 of the drawings, which is also the arrangement used for the in-shell egg pasteurization machine 10. A longitudinal axis of each in-shell egg 40 is thus transverse to a direction of travel of the in-shell egg 40. Adjacent in-shell eggs 40 in a longitudinally extending column of in-shell eggs 40 are spaced about 5 mm apart by the egg supporting formations 38. In other words, each column of in-shell eggs 40 has a pitch of about 5 mm. Transversely aligned in-shell eggs 40, i.e. adjacent eggs in the two columns of in-shell eggs 40, are spaced about 8 mm.

The egg supporting formations 38 of an endless egg support 36 are in turn supported on their tyres 39 on the floor 24 of the associated longitudinally extending microwave cavity 16 of the endless egg support 36. The egg supporting formations 38 are rotatable about an axis extending laterally between the plates or links 37 of the endless egg support 36. As the endless egg support 36 is thus displaced through its associated longitudinally extending microwave cavity 16, the egg supporting formations 38 rotate on their tyres 39 which in turn causes the in-shell eggs 40 supported on and by the egg supporting formations 38 to rotate, in a direction opposite to the direction of rotation of the egg supporting formations 38, about an axis extending transversely to the direction of travel of the in-shell eggs 40.

The egg supporting formations 38 raise the in-shell eggs 40 above the floor 24 of the longitudinally extending microwave cavity 16 through which the eggs 40 are being displaced. Typically, the in-shell eggs 40 are elevated about 20 mm above the floor 24.

The endless egg support 36 of each longitudinally extending microwave cavity 16 also pass through the pasteurization stage 14 (i.e. through each of the modules of the pasteurization stage 14) and are supported on an upper floor of each of the modules of the pasteurization stage 14 so that the in-shell eggs 40 are also rotated as they move through the pasteurization stage 14.

Both the temperature raising stage 12 and the pasteurization stage 14 define a lower floor, below the floor 24 of the longitudinally extending microwave cavity 16 and the upper floor of the pasteurization stage 14, upon which the endless egg supports 36 are supported during their return runs, as can be clearly seen in FIG. 2.

Infrared temperature sensors (not shown) are provided at the outlet 20 of each longitudinally extending microwave cavity 16 to measure the external egg shell temperature of the in-shell eggs 40 exiting the longitudinally extending microwave cavities 16. This information is used as input to the programmable controller in order to manipulate the amount of microwave power fed into the longitudinally extending microwave cavity 16. Similarly, infrared temperature sensors (not shown) are provided on an end station 42 of the machine 10 to measure the external egg shell temperature of the in-shell eggs 40 leaving the pasteurization stage 14.

The end station 42 also includes a printer 46 to print pasteurization information, e.g. batch number, date and temperature, on each in-shell egg 40 as it leaves the pasteurization stage 14. Furthermore, the end station 42 provides a pair of geared drive wheels for each endless egg support 36 and, at a lower elevation, a pair of geared idler wheels for each endless egg support 36. The upper geared drive wheels of all of the endless egg supports 36 are on a common shaft and are driven by an electric motor to rotate at the same rate as the geared drive wheels at the inlet end 44 of the machine 10. If desired, the lower geared wheels may also be driven so that they do not merely idle.

The in-shell egg pasteurization machine 10 is typically serviced by, or includes an automated egg loader (not shown) for loading in-shell eggs onto the egg supporting formations 38 at the feed end 44 of the pasteurization machine 10, as well as an automated egg packer (not shown) to remove pasteurized in-shell eggs from the end station 42 and to pack the pasteurized in-shell eggs 40 onto egg trays. The in-shell eggs 40 are typically graded to fall within a preselected weight band.

Thus, in use, graded in-shell eggs 40 are placed, at the feed end 44, on the egg supporting formations 38 of each of the endless egg supports 36, continuously to form continuous columns of in-shell eggs 40, as the endless egg supports 36 are being displaced to feed the columns of in-shell eggs 40 through the temperature raising stage 12 and then through the pasteurization stage 14. Each in-shell egg 40 is placed with a longitudinal axis (i.e. an axis passing through the blunt end and the more pointed end of the in-shell egg 40) of the in-shell egg 40 arranged transversely to the direction of travel of the two egg supporting formations 38 on which the in-shell egg 40 is being supported. Each endless egg support 36 will thus support two columns of in-shell eggs 40, with the in-shell eggs 40 in a left-hand column being in register with the in-shell eggs 40 in a right-hand column, and with all of the in-shell eggs being slowly rotated about their longitudinal axes at a rate of one revolution per about 0.25 m. The more rounded or less tapered or blunter ends of the in-shell eggs 40 in the left-hand column face the more rounded or less tapered or blunter ends of the eggs 40 in the right-hand column. In other words, the ends of the in-shell eggs 40 containing the air sacks of the eggs 40 in the two columns are turned towards each other. Advantageously, this arrangement reduces or even eliminates arcing between the eggs of the two adjacent columns of eggs inside the longitudinally extending microwave cavities 16 during microwave irradiation.

Whilst travelling through the longitudinally extending microwave cavities 16 of the temperature raising stage 12, the two side by side columns of in-shell eggs 40 on the endless egg supports 36 are irradiated with microwaves at a frequency of 915 MHz, thereby to heat the in-shell eggs 40 internally. Simultaneously, the eggs 40 are heated externally by means of the heated floors 24 and side walls 22 of the longitudinally extending microwave cavity 16 through which the in-shell eggs 40 are passing. The floors 24 and side walls 22 are typically maintained at a temperature of about 63° C. In addition, hot air generated inside the pasteurization stage 14, at a temperature of about 58° C. is displaced upstream through the longitudinally extending microwave cavities 16, against the direction of travel of the in-shell eggs 40. Advantageously, heating of the in-shell eggs 40 externally by means of the heated side walls 22 and floors 24, and by means of the hot air, reduces heat loss from the in-shell eggs 40, e.g. as a result of moisture loss, as they are being irradiated with microwaves.

As shown in FIG. 11 of the drawings, the microwave electric field distribution in a longitudinally extending microwave cavity 16 is substantially uniform across the width of the longitudinally extending microwave cavity 16. This results in the in-shell eggs 40 in the left-hand column of eggs passing through a longitudinally extending microwave cavity 16 being heated substantially at the same rate, and hence to the same temperature (as they are similar in weight), as in-shell eggs 40 in the right-hand column of eggs passing through the same longitudinally extending microwave cavity 16, as shown in FIG. 8 of the drawings.

As a result of the sizing and spacing of the microwave coupling openings 30 in the roof 26 of each longitudinally extending microwave cavity 16, more microwave energy enters each longitudinally extending microwave cavity 16 upstream, i.e. closer to the feed end 44 or to the inlet 18, than downstream, i.e. closer to the outlet 20. This results in a typical heating profile for the in-shell eggs 40 as shown in FIG. 7 of the drawings. As will be noted, the temperature of the in-shell eggs 40 initially and for a relatively short period increases along an exponential curve but thereafter the rate at which the in-shell eggs 40 are heated reduces, so that the temperature of the in-shell eggs 40 as a function of time, and hence as a function of longitudinal position inside the longitudinally extending microwave cavity 16, eventually follows an inverse logarithmic curve, plateauing out at a target pasteurization temperature, e.g. 59.5° C. Typically, the residence time of the in-shell eggs 40 in the temperature raising stage 12 is about 17 minutes.

The infrared temperature sensors provided for each column of in-shell eggs 40 measure the external egg shell temperature of an in-shell egg 40 as the egg 40 leaves the temperature raising stage 12. As shown in FIG. 10, there is a linear relationship between the measured infrared shell temperature and the internal temperature of the yolk of an in-shell egg 40, as measured by an optic fibre inserted into the yolk. Hence, by controlling the microwave power fed to a longitudinally extending microwave cavity 16 in response to the measured infrared temperatures of the in-shell eggs 40 leaving the pasteurization stage 14, the yolk temperature of the in-shell eggs 40 leaving the pasteurization stage 14 can be controlled between about 57° C. and about 60° C. As will be appreciated, with the yolk being controlled at this temperature, the albumen of the in-shell eggs 40 is guaranteed to be at a slightly lower temperature of about 53° C. to about 58° C. Furthermore, as shown in FIG. 9 of the drawings, with the egg yolk being raised to a temperature of between 57° C. and 60° C., and maintained at this temperature for a sufficient pasteurization time, a sufficient log reduction in the target microorganisms, including Salmonella enteritides phage type 4 (PT4) and phage type 8 (PT8) is achieved for the eggs to be considered pasteurized.

The in-shell eggs 40 leaving the temperature raising stage 12 immediately enter the pasteurization stage 14 and travel through the modules of the pasteurization stage 14, whilst all the time being rotated slowly about their longitudinal axes. The air temperature inside each module of the pasteurization stage 14 is controlled to be about 58° C. and the residence time of the in-shell eggs 40 in the pasteurization stage 14 is about 35 minutes. No microwave energy is fed into the pasteurization stage 14, but heat loss from the in-shell eggs 40 is inhibited by means of the hot air. As the in-shell eggs 40 leave the pasteurization stage 14, the temperature of each in-shell egg 40 is again measured by means of an infrared temperature sensor. Pasteurization information is then printed on the in-shell egg 40 by means of the printer 46 whereafter the in-shell egg 40 is removed and packaged, preferably by an automated egg packer.

The in-shell egg pasteurization machine 10, as illustrated, advantageously allows pasteurization of unpackaged whole in-shell eggs, using microwave energy without damaging the albumen of the in-shell eggs. The machine 10, as illustrated, is able to pasteurize in-shell eggs at a rate of about 4000 eggs per hour, which is commercially attractive. As will be appreciated, this rate can be increased e.g. by increasing the width of each longitudinally extending microwave cavity 16 for example to accommodate three or four columns of in-shell eggs, or by increasing the number of longitudinally extending microwave cavities 16, or by attaching multiple machines to a single high powered microwave source.

Importantly, the longitudinally extending microwave cavities 16 are isolated from one another so that microwave energy does not leak from one longitudinally extending microwave cavity 16 into another longitudinally extending microwave cavity 16, thereby ensuring that microwave field density measured in a direction transverse to the direction of travel of in-shell eggs 40 through a longitudinally extending microwave cavity 16 is substantially uniform, even as the microwave field density is adjusted or controlled in order to control the temperature of the in-shell eggs.

As the microwave splitters are electrically adjustable by means of a closed control loop, the microwave power to each longitudinally extending microwave cavity 16 can individually be controlled. This allows optimum temperature regulation to accommodate changes in the size or mass of eggs in a longitudinally extending microwave cavity 16. Ensuring that the microwave power density in the longitudinally extending microwave cavities 16 is profiled to progressively reduce the heating rate of the in-shell eggs passing through the longitudinally extending microwave cavities 16, the heat flux in the eggs as they approach their target temperatures is reduced, thereby advantageously preventing thermal damage from large temperature variations in the eggs under rapid heating conditions. At the same time, this reduces the total pasteurization processing time required, as the in-shell eggs are initially rapidly heated while they are cold, with the heating rate only later being reduced. In this way thermal damage to the eggs due to extended times at elevated temperatures is minimized.

The apparatus 10, as illustrated, employs non-contact temperature measurement of egg shell temperatures. It has been shown to be a valid method to deduce the temperature of the yolk of the in-shell eggs, which temperature is the critical temperature from a pasteurization point of view.

1. An in-shell egg pasteurization process which includes
in a temperature-raising stage, raising the temperature of yolk of a plurality of in-shell eggs, simultaneously and at least predominantly by means of microwave radiation, to a pasteurization temperature, the temperature-raising stage including a plurality of elongate or longitudinally extending microwave cavities that are isolated from one another so that microwaves fed into an elongate or longitudinally extending microwave cavity do not leak into any other elongate or longitudinally extending microwave cavity, with the in-shell eggs being displaced along the lengths of the elongate or longitudinally extending microwave cavities whilst being irradiated with microwaves; and
in a pasteurization stage, maintaining the raised temperatures of the in-shell eggs for a pasteurization time sufficient to pasteurize the in-shell eggs.

2. The process according to claim 1, wherein the elongate or longitudinally extending microwave cavities are arranged side-by-side, with longitudinally extending axes of the elongate or longitudinally extending microwave cavities being parallel.

3. The process according to claim 1 or claim 2, wherein at least two of the number of columns of in-shell eggs in an elongate or longitudinally extending microwave cavity, the microwave frequency and the microwave wavelength are selected from the following table:

| Columns of in-shell eggs in an | Microwave | Microwave |
|---|---|---|
| elongate or longitudinally extending | frequency range | wavelength |
| microwave cavity | (GHz) | range (cm) |
| 1 | 0.3-10 | 3-100 |
| 2 | 0.3-2.5 | 12-100 |
| 3 | 0.3-1.5 | 20-100 |
| 4 | 0.3-1 | 30-100 |

4. The process according to claim 1 or claim 2, wherein the number of columns of in-shell eggs in an elongate or longitudinally extending microwave cavity and the width of each elongate or longitudinally extending microwave cavity are selected from the following table:

| Columns of in-shell eggs in | |
|---|---|
| an elongate or longitudinally | Elongate or longitudinally extending |
| extending microwave cavity | microwave cavity width range (cm) |
| 1 | 7-15 |
| 2 | 14-25 |
| 3 | 21-30 |
| 4 | 28-40 |

5. The process according to any of claims 1 to 4, wherein the in-shell eggs being displaced along the length of an elongate or longitudinally extending microwave cavity are arranged with a longitudinal axis of each in-shell egg being transverse to the direction of travel of the in-shell egg.

6. The process according to any of claims 1 to 5, which includes heating a floor and/or side walls of the elongate or longitudinally extending microwave cavities, thereby to also heat at least the external or shell surfaces of the in-shell eggs by means of heat radiation or thermal radiation.

7. The process according to any of claims 1 to 6, which includes moving hot air through the temperature-raising stage whilst the temperature of yolk of a plurality of in-shell eggs are being raised simultaneously and at least predominantly by means of microwave radiation to a pasteurization temperature.

8. The process according to any of claims 1 to 7, which includes turning eggs passing through an elongate or longitudinally extending microwave cavity about their longitudinal axes at least while they are within the elongate or longitudinally extending microwave cavity.

9. The process according to any of claims 1 to 8, which includes measuring a surface temperature of in-shell eggs inside an elongate or longitudinally extending microwave cavity, and correlating the yolk temperature of the eggs based on the surface temperature.

10. An in-shell egg pasteurization machine or installation which includes
a temperature raising stage to raise the temperatures of in-shell eggs by means of microwave radiation, the temperature raising stage including a plurality of elongate or longitudinally extending microwave cavities that are isolated from one another so that microwaves fed into one elongate or longitudinally extending microwave cavity do not leak into any other elongate or longitudinally extending microwave cavity; and
a pasteurization stage configured to maintain raised temperatures of in-shell eggs received from the temperature raising stage for a pasteurization time sufficient to pasteurize the in-shell eggs.

11. The in-shell egg pasteurization machine or installation according to claim 10, which includes conveying means passing longitudinally through each elongate or longitudinally extending microwave cavity to displace in-shell eggs along the lengths of the elongate or longitudinally extending microwave cavities.

12. The in-shell egg pasteurization machine or installation according to claim 10 or claim 11, wherein the conveying means is configured to support in-shell eggs in an elongate or longitudinally extending microwave cavity with a longitudinal axis of each in-shell egg arranged transverse to a longitudinal direction of the elongate or longitudinally extending microwave cavity.

13. The in-shell egg pasteurization machine or installation according to any of claims 10 to 12, which includes heated floor and/or side walls defining the elongate or longitudinally extending microwave cavities.

14. The in-shell egg pasteurization machine or installation according to any of claims 10 to 13, which includes a hot air generator to generate or produce hot air for the pasteurization stage.

15. The in-shell egg pasteurization machine or installation according to any of claims 10 to 14, which includes microwave splitters to split total microwave power generated by a microwave generator into microwave power portions, and to feed portions of microwave power so obtained to each elongate or longitudinally extending microwave cavity configured for eggs to pass through the elongate or longitudinally extending microwave cavity, and a controller configured to control microwave power to each elongate or longitudinally extending microwave cavity such that the yolks of the eggs in the temperature raising stage are raised to a pasteurization temperature, the controller being configured to receive as set points or references the surface temperature of in-shell eggs at a selected or predetermined location within each of the elongate or longitudinally extending microwave cavities.
